(19) United States
(12) Patent Application Publication
(10) Pub. No.: US 2026/0149726 A1
(43) Pub. Date: May 28, 2026

(54) PROTOCOL DATA UNIT PAYLOAD BASED CYBERATTACK DETECTION

(71) Applicant: Palo Alto Networks, Inc., Santa Clara, CA (US)

(72) Inventors: Yiheng An, San Jose, CA (US); Haozhe Zhang, San Jose, CA (US); Zhibin Zhang, Santa Clara, CA (US); Qi Deng, Sunnyvale, CA (US); Shengming Xu, San Jose, CA (US)

(21) Appl. No.: 19/025,266

(22) Filed: Jan. 16, 2025

Related U.S. Application Data
(60) Provisional application No. 63/724,141, filed on Nov. 22, 2024.

(51) Int. Cl. H04L 9/40

(52) U.S. Cl. CPC H04L 63/1425; H04L 63/1416

(57) ABSTRACT

A system has been designed for inline detection of various cybersecurity attacks in network traffic delineated based on patterns detected in payloads of protocol data units (PDUs) of the network traffic. Patterns of the various attacks are distributed across points of network traffic inspection for inline detection, such as firewalls, of the patterns in payloads. If a pattern is detected, then an analyzer corresponding to the suspected attack is invoked and provided the suspicious payload. The analyzers can be provided as cloud-based services. The patterns and analyzers have been created for inline detection of insecure deserialization, malicious XML, XSS attacks, and XXE attacks. Each of these is referred to herein as a detector: insecure deserialization detector, malicious XML detector, XSS attack detector, and XXE attack detector.

### BACKGROUND

The disclosure generally relates to machine-learning based insecure deserialization detection (e.g., CPC subclass G06N and/or H04L 63).

OWASP (Open Web Application Security Project) describes Insecure Deserialization as “a type of vulnerability that arises when untrusted data is used to abuse the logic of an application's deserialization process, allowing an attacker to execute code, manipulate objects, or perform injection attacks.” Serialization and deserialization are often performed to communicate data between applications while preserving the structure of the data. An application will serialize structured data/objects into serialized data and communicate the serialized data to another application. The receiving application will then deserialize the serialized data to recreate the object. Formatting or markup languages, such as XML (extensible markup language) and JSON (Javascript® Object Notation), are used to represent serialized data. Programming languages (e.g., the PHP programming language, the Java® programming language, and the Python® programming language) provide native capabilities for serializing and deserializing that have more features than JSON or XML. However, malicious actors leverage these additional features for insecure deserialization. With a malicious object inserted into a web application via insecure deserialization, a malicious actor can cause a denial-of-service (DOS) attack, remote code execution attack, authentication bypass, and path traversal.

OWASP describes Cross-Site Scripting (XSS) attacks injection type attacks that inject malicious code into websites that are typically trusted or benign. Typically, a malicious actor will use a web application to send malicious code (e.g., a browser side script) to a different end user via a trusted/benign website. The victim end user's browser will execute the script since the browser receives the script from the trusted/benign website. The malicious script can access any cookies, session tokens, or other sensitive information retained by the browser and used with that website. XSS has been classified as Reflected XSS, Stored XSS, or DOM-based XSS. But XSS often falls within multiple of these categories, so researchers generally categorized XSS as Server XSS or client XSS. Despite XSS attacks being present for many years, detection is still challenging, at least because minor variations in XSS evade signature-based detection. XSS attacks can be used to incur financial losses, compromise sensitive data, distribute malware deface websites, launch phishing campaigns, etc.

Extensible Markup Language (XML) files are plain text files structured to store and transport data in a readable, hierarchical format. XML uses custom, user-defined tags to organize information. The data are typically organized as elements enclosed by tags, with attributes optionally providing additional metadata. XML files can be used to carry out attacks, often by targeting systems or applications that process XML files. For instance, XML files can comprise malicious code, including code that exploits vulnerabilities. Examples of attacks that may be carried out via XML include XML External Entity (XXE) attacks, XML or XPath injection, and denial-of-service (DOS) attacks.

OWASP defines an XML External Entity (XXE) attack as “a type of attack against an application that parses XML input. This attack occurs when XML input containing a reference to an external entity is processed by a weakly configured XML parser.” An XML External Entity attack can be used for data exfiltration, denial of service, server-side request forgery, and port scanning from the perspective of the parser host.

### BRIEF DESCRIPTION OF THE DRAWINGS

Embodiments of the disclosure may be better understood by referencing the accompanying drawings.

FIG. 1 is a conceptual diagram of inline detection of various cyberattacks based on inline detection of attack correlated patterns in payloads of protocol data units (PDUs) in network traffic.

FIG. 2 is a diagram of a firewall interacting with an insecure deserialization detector to analyze network traffic.

FIG. 3 is a flowchart of example operations for detecting insecure deserialization with a multi-perspective machine learning ensemble.

FIG. 4 is a flowchart of example operations for resolving multiple object chains to an insecure deserialization prediction.

FIG. 5 is a flowchart of example operations for training models to detect insecure deserialization detector based on multiple perspectives of a payload.

FIG. 6 is a flowchart of example operations for inline detection of an XXE injection.

FIG. 7 depicts an example computer system with a multi-perspective machine learning based insecure deserialization detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

A system has been designed for inline detection of various cybersecurity attacks in network traffic delineated based on patterns detected in payloads of protocol data units (PDUs) of the network traffic. Patterns of the various attacks are distributed across points of network traffic inspection for inline detection, such as firewalls, of the patterns in payloads. If a pattern is detected, then an analyzer corresponding to the suspected attack is invoked and provided the suspicious payload. The analyzers can be provided as cloud-based services. The patterns and analyzers have been created for inline detection of insecure deserialization, malicious XML, XSS attacks, and XXE attacks. Each of these is referred to herein as a detector: insecure deserialization detector, malicious XML detector, XSS attack detector, and XXE attack detector.

The insecure deserialization detector is powered by an artificial intelligence (AI) ensemble. The insecure deserialization detector includes a deep learning model that has been trained from an object chain “perspective” of insecure deserialization and a machine learning model that has been trained from a heuristics-based perspective of insecure deserialization. If a pattern associated with insecure deserialization is detected in network traffic, a corresponding payload is submitted for analysis by the insecure deserialization detector. The insecure deserialization detector decodes serialized data of the payload to reconstruct an order-sensitive object chain and to extract values from the serialized data. The insecure deserialization detector vectorizes the object chain to generate an object chain-based feature vector and inputs the object chain feature vector into the deep learning model to obtain a first prediction. The insecure deserialization detector also vectorizes the extracted values to generate a values-based feature vector and inputs the tokenized values feature vector into the machine learning model to obtain a second prediction. The insecure deserialization detector combines the predictions and generates a verdict based on the combination of predictions.

### Example Illustrations

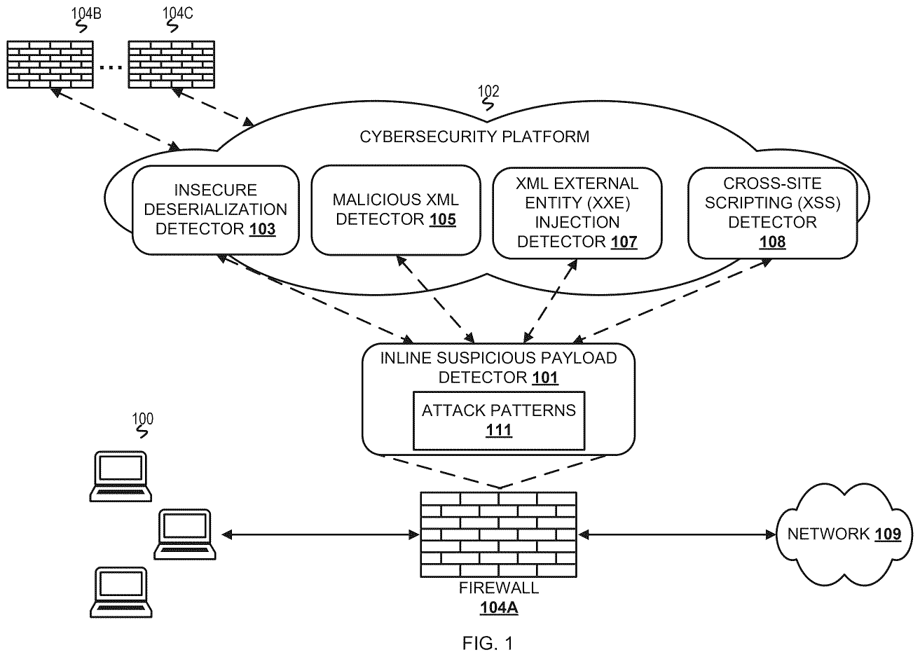

FIG. 1 is a conceptual diagram of inline detection of various cyberattacks based on inline detection of attack correlated patterns in payloads of PDUs in network traffic. FIG. 1 depicts a fleet of firewalls including firewalls 104A, 104B, 104C. Each of the firewalls 104A, 104B, 104C can be a cloud-based firewall, a virtual firewall, or a physical firewall deployed to inspect network traffic sent to and from network 109. The firewalls 104A-104C interact with cybersecurity platform 102 to provide inline detection of various cyberattacks and protect the network 109. The cybersecurity platform 102 provides an insecure deserialization detector 103, a malicious XML detector 105, an XXE injection detector 107, and a XSS attack detector 108. Each of the firewalls 104A, 104B, 104C inspects payloads of PDUs for patterns correlated with cybersecurity attacks or presence of content relevant to a cyberattack (e.g., presence of XML or serialized data). FIG. 1 depicts a plurality of network traffic sources 100. Each of the insecure deserialization detector 103, malicious XML detector 105, XXE injection detector 107, and XSS detector 108 (collectively “the detectors 103, 105, 107, 108”) analyze payloads provided from the fleet of firewalls and returns a verdict. Based on the verdict, the relevant firewall can take a security action for the corresponding network traffic. For instance, a malicious verdict from any one of the detectors 103, 105, 107, 108 causes the firewall to enforce a policy, such as isolating and/or blocking any further traffic of a network traffic flow corresponding to the malicious payload.

While each of the firewalls 104A-104C will include similar functionality for inline detection, the description will focus on the firewall 104A. In addition, the inspection of payloads to detect patterns can be implemented on another network device that is not a firewall or cybersecurity appliance. The firewall 104A includes a suspicious payload detector 101 that executes on the firewall 104A. The suspicious payload detector 101 identifies payloads in network traffic that are suspicious based on heuristics-based rules. The heuristics-based rules specify patterns 111 for the different cyberattacks that have been observed in malicious payloads or typical patterns or keywords that indicate presence of content relevant to a cyberattack. The patterns 111 can comprise explicit patterns and regular expressions that have been defined based on heuristics for the different cyberattacks. The suspicious payload detector 101 can use deep packet inspection to evaluate payloads against the attack patterns 111. When a pattern is detected, a rule is triggered that causes the firewall 104A to forward the suspicious payload to a relevant one of the detectors 103, 105, 107, 108. In some cases, a payload may match defined patterns for multiple of the different attacks. In these cases, the firewall 104A would submit the payload to the multiple relevant ones of the detectors 103, 105, 107, 108. Embodiments do not necessarily examine payloads for the patterns. Instead, the payloads can be sampled and submitted to the detectors 103, 105, 107, 108. However, the identification of suspicious payloads can be used as a pre-filtering operation to reduce the number of requests submitted to the detectors 103, 105, 107, 108.

Cybersecurity platform 102 may provide multiple instances of the detectors 103, 105, 107, 108 (e.g., for load balancing, for different jurisdictions or geographic zones, for different cloud infrastructures, etc.). Despite the availability of multiple instances, any one of the detectors 103, 105, 107, 108 may receive requests from different firewalls for payload analysis and attack detection. The request messages will include identifying information (e.g., source network address) to identify the requesting firewall and allow the detectors 103, 105, 107, 108 to respond to the appropriate firewall or inspection point with a verdict. Firewall configuration can vary to either allow a PDU for which the payload is being analyzed to be transmitted without delay or to be delayed until a verdict is received.

The XSS detector 108 is an artificial intelligence ensemble developed for XSS detection with high accuracy. The artificial intelligence ensemble is created with a deep learning model and a machine learning model, each trained on different perspectives of token sequences extracted from packet payloads. Pre-processing of the raw data (i.e., the packet payload) generates a sequence of tokens that represents the payload and then generates a sequence of abstract tokens from the sequence of tokens. The deep learning model is trained on abstract token sequences to detect XSS from the perspective of patterns of token sequences. The other model is trained on pattern-based features extracted from the sequence of tokens to detect XSS from the perspective of features corresponding to characteristics of tokens sequences corresponding to heuristics gleaned for XSS. After each model is trained, the models are combined and deployed for inline detection of XSS in payload traffic from the different perspectives.

The malicious XML detector 105 uses a combination of heuristic analysis and deep learning. The malicious XML detector 105 splits detected XML files forwarded from the firewall 104A into its header and document components and analyzes each separately for maliciousness, as XML headers and documents can comprise different malicious indicators. Header analysis leverages heuristics, such as rules and/or patterns. The malicious XML detector 105 first analyzes the document with heuristics-based rules. If this detection yields a verdict that the XML document is malicious, the malicious XML detector 105 can provide a malicious verdict for the XML document without further inspection. Otherwise, the XML document is subject to further analysis using a trained model such as a Tree-LSTM (long term short term memory) model. Tree-LSTM models may be employed because these models have been designed for processing hierarchical data, so the hierarchical structure of the XML document can be preserved in inputs to the model. The malicious XML detector 105 generates a verdict for the XML file based on the results of analysis of both the header and document and returns the verdict to the firewall 104A for the traffic to be blocked (if the XML file is determined to be malicious) or allowed (if the XML file is determined not to be malicious) accordingly.

If XML content is detected in a payload, then the XXE injection detector 107 evaluates the payload against a set of rules related to document type definition (DTD) extracted from the payload. The type of DTD, file-based or link-based, leads to different evaluations. In some cases, the XXE injection detector 107 will coordinate with the requesting firewall 104A to identify inline a response to the PDU that included the suspicious payload and analyze a payload response PDU to prevent data exfiltration.

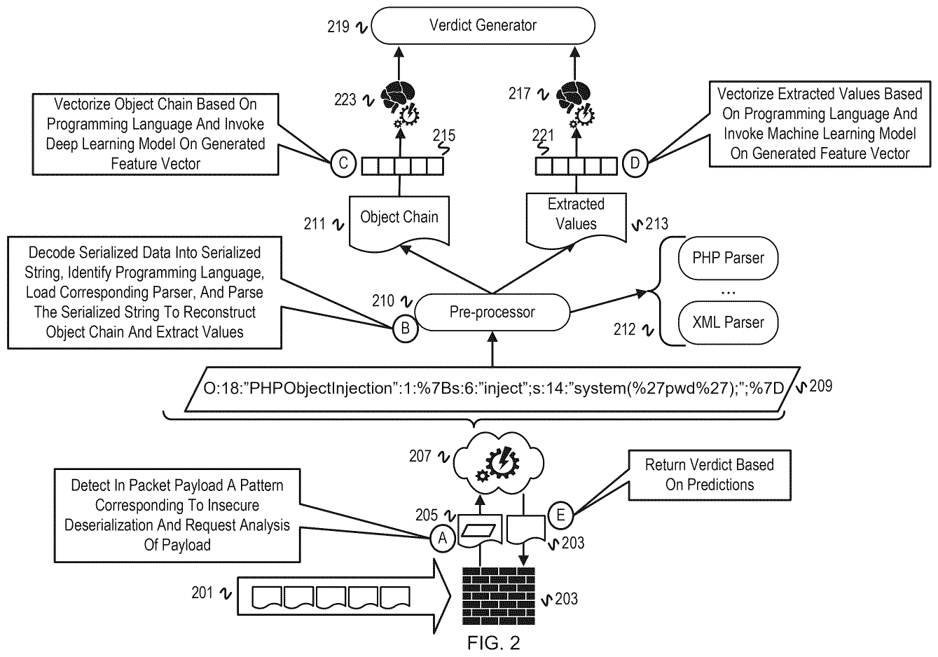

FIG. 2 is a diagram of a firewall interacting with an insecure deserialization detector to analyze network traffic. FIG. 2 illustrates a deployment of a multi-perspective insecure deserialization detector 207 for inline detection of insecure deserialization strings in network traffic 201 for a firewall 203. The multi-perspective insecure deserialization detector 207 can be exposed to the firewall 203 as a cloud-based service accessible via web application programming interface (API) calls or locally hosted. The multi-perspective insecure deserialization detector 207 includes a pre-processor 210, a machine-learning model 217, a deep learning model 223, and a verdict generator 219.

FIG. 2 is annotated with a series of letters A-E representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the firewall 203 detects in packet payload a pattern corresponding to insecure deserialization. The firewall 203 scans network traffic 201 against one or more patterns, at least one of which indicates serialized data in a payload. For example, the firewall 203 uses deep packet inspection to search payloads for a pattern(s) or regular expression, such as “O:\d+:\“[\hat{ }\”]+\“:\d+:{.*?\}”, that indicates the presence of serialized data. In the example regular expression, the ‘d’ is a wildcard for any digit or integer. Upon detection of a serialized data pattern, the firewall 203 requests analysis of a payload by the multi-perspective insecure deserialization detector 207. In this illustration, the firewall 203 detects the serialized data pattern in a payload and submits a request 205 that includes the payload.

At stage B, the pre-processor 210 of the multi-perspective insecure deserialization detector 207 pre-processes the serialized data in the payload to obtain a string and representations of different perspectives of the serialized data for predicting whether insecure deserialization is present. This pre-processing includes decoding the serialized data into a serialized string, identifying a programming language of the serialized string, and parsing the serialized data according to the identified programming language. FIG. 2 depicts serialized data O:18:“PHPObjectInjection”:1:%7Bs:6: “inject”;s:14:“system(%27pwd%27);”; % 7D from a payload 209. The pre-processor 210 decodes this serialized data into a serialized string “O:18: “PHPObjectInjection”:1:{s:6: “inject”;s:14: “system(‘pwd’);”;}”. Based on the identified programming language, the pre-processor 210 selects one of a set of programming language specific parsers 212, depicted as at least including an XML parser and a PHP® parser. With the appropriate one of the parsers 212, the pre-processor 210 parses the serialized string to reconstruct an object chain 211 and to extract values 213. In the case of FIG. 2, the pre-processor 210 selects the PHP parser since PHP is identified in the payload 209. Of course, a payload can contain serialized data in multiple programming languages and cause the pre-processor 210 to select multiple ones of the parsers 212.

At stage C, the multi-perspective insecure deserialization detector 207 vectorizes the object chain 211 and invokes a deep learning model 223 on a feature vector 215. The multi-perspective insecure deserialization detector 207 selects from multiple vectorize functions based on the programming language to generate the feature vector 215 from the object chain 211. The multi-perspective insecure deserialization detector 207 then invokes the deep learning model 223 on the feature vector 215 to obtain a prediction of whether the serialized data of the packet payload includes insecure deserialization from a perspective of object chains.

At stage D, the multi-perspective insecure deserialization detector 207 vectorizes the extracted values 213 and invokes the machine learning model 223 on a feature vector 221. The multi-perspective insecure deserialization detector 207 selects from multiple vectorize functions based on the programming language to generate the feature vector 221 from the extracted values 213. The multi-perspective insecure deserialization detector 207 then invokes the machine learning model 223 on the feature vector 221.

At stage E, the multi-perspective insecure deserialization detector 207 returns a verdict to the firewall 203 based on predictions from the models 217, 223. The multi-perspective insecure deserialization detector 207 generates a verdict based on predictions from the models 217, 223. The multi-perspective insecure deserialization detector 207 can aggregate the predictions (e.g., select a greater prediction or average the predictions). If the greater prediction or prediction average is sufficient for malicious indication, the multi-perspective insecure deserialization detector 207 returns a verdict that insecure deserialization was detected. Based on the verdict, the firewall 203 can perform a security action, such as blocking or allowing traffic.

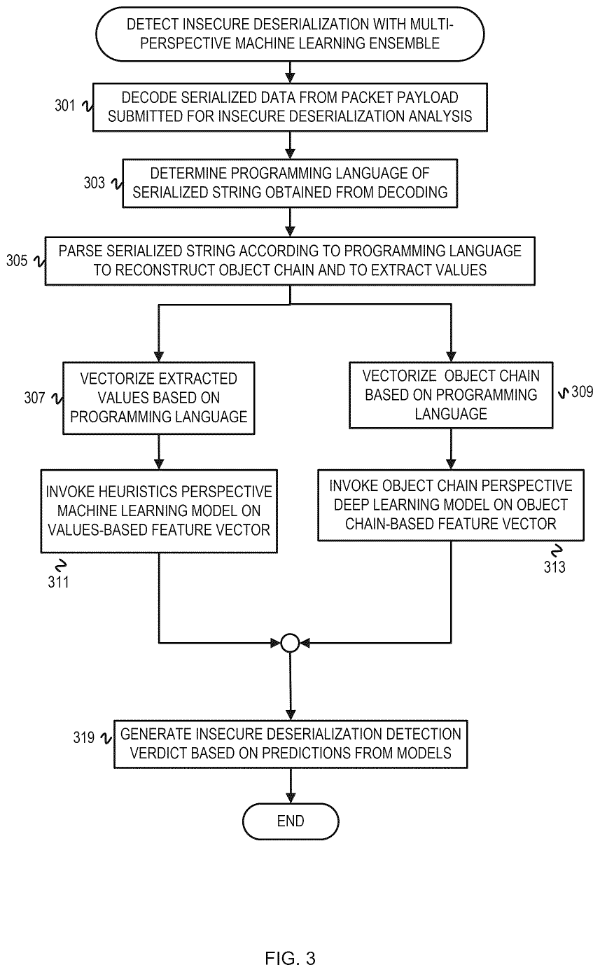

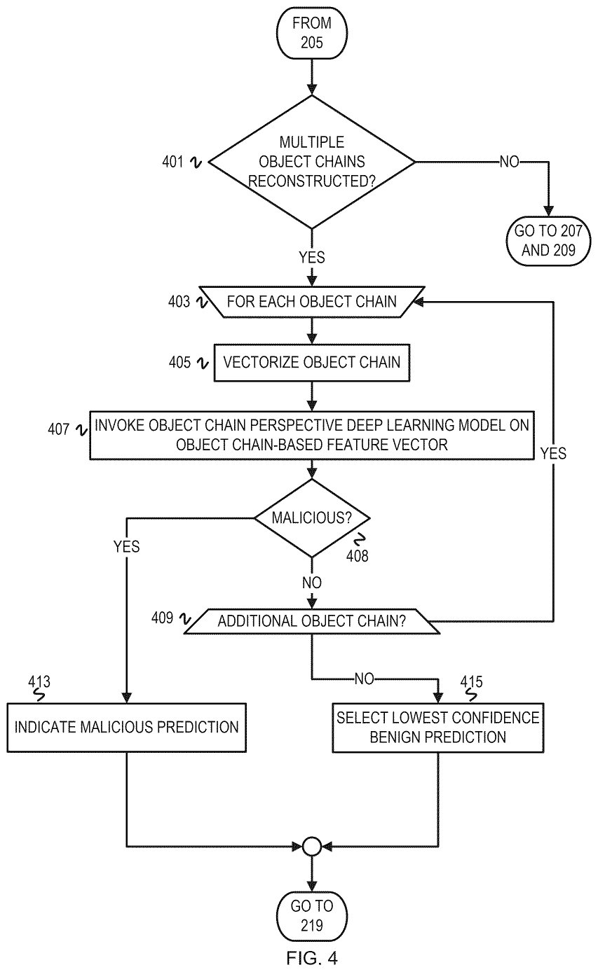

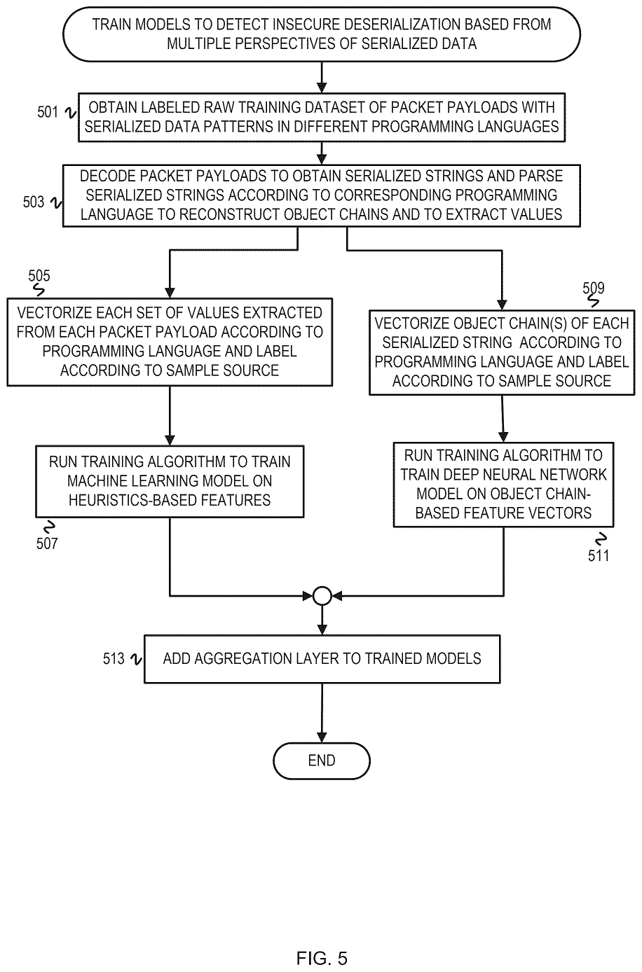

FIGS. 3-5 are flowcharts corresponding to using and training the multi-perspective insecure deserialization detector. The example operations of FIGS. 3 and 4 are described with reference to an insecure deserialization detector as a shorter version of multi-perspective insecure deserialization detector for consistency with FIG. 2 and/or ease of understanding. The example operations of FIG. 5 are described with reference to a trainer. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for detecting insecure deserialization with a multi-perspective machine learning ensemble. As noted, the multi-perspective machine learning ensemble will be referred to as the insecure deserialization detector for brevity. While any payload can be provided to the insecure deserialization detector for analysis, the initial filtering by pattern matching as depicted in FIG. 3 is a possible embodiment to conserve resources and/or reduce queries to the insecure deserialization detector. Since there are two pre-processing paths for the two different models, parallelism can be implemented until synchronization for verdict generation.

At block 301, the insecure deserialization detector decodes serialized data extracted from a packet payload that has been submitted for analysis. The insecure deserialization detector decodes the serialized data to obtain a serialized string. For example, the insecure deserialization detector uses any one of URL decoder, a Base64 decoder, and a hexadecimal decoder or hexadecimal to ASCII decoder.

At block 303, the insecure deserialization detector determines a programming language based on the serialized string. The insecure deserialization detector searches the serialized string for a pattern or regular expression corresponding to a programming language. For example, the insecure deserialization detector can search a serialized string for bytes that start with 0xAC or 0xED to determine that the programming language is the Java® programming language. As another example, the insecure deserialization detector can search a serialized string for a regular expression corresponding to PHP format.

At block 305, the insecure deserialization detector parses the serialized string according to the determined programming language. The insecure deserialization detector loads a parser for the determined programming language. While parsing, the insecure deserialization detector determines whether a value (e.g., value assigned to a field or key) is detected. If so, the insecure deserialization detector updates a list of values extracted from the serialized string. In addition, the insecure deserialization detector reconstructs an object chain while parsing. The insecure deserialization detector can ascertain from the delimiters or arrangement of characters in the serialized string a hierarchy of objects. Implementations for reconstructing an object chain can vary as long as the same scheme is used when training. For instance, markers can be used to indicate a hierarchical level and ordering for direct relationships. Assume an object chain in a serialized string A{B, C{D, E}, F}. The insecure deserialization detector can reconstruct the object chain to indicate the hierarchy and relationships for vectorizing as A0B1C1D2E2F1. This is a simple example to illustrate the reconstruction being indicating the chain of objects in a manner that preserves the hierarchical relationships and can be represented in a vector.

With the object chain and the extracted values, the insecure deserialization runs an execution path to obtain a prediction based on the values (blocks 307 and 311) and an execution path to obtain a prediction based on the object chain (blocks 309 and 313). FIG. 3 depicts these execution paths as occurring in parallel, but parallelism is not necessary.

At block 309, the insecure deserialization detector vectorizes the object chain based on the programming language. For instance, the insecure deserialization detector selects a library defined method/function to vectorize at a granularity of character, n-gram, or byte depending on the programming language. For example, the insecure deserialization detector can select a fastText vectorizer or character-level frequency vectorizer for a PHP object chain. As another example, the insecure deserialization detector can select a byte-level n-gram frequency vectorizer for a Java object chain.

At block 313, the insecure deserialization detector invokes an object chain perspective deep learning model on the feature vector generated from vectorizing the object chain. The object chain perspective deep learning model is a deep learning model (e.g., a LSTM (Long Short Term Memory), a RNN (Recurrent Neural Network) model, a CNN (Convolutional Neural Network) model, etc.). The deep learning model has been trained to detect insecure deserialization based on patterns in object chains learned by the deep learning model as corresponding to insecure deserialization. Operational flow proceeds to block 319.

At block 307, the insecure deserialization detector vectorizes the values based on the programming language. For instance, the insecure deserialization detector selects a library defined method/function to vectorize at a granularity of character or n-gram depending on the programming language.

At block 311, the insecure deserialization detector invokes a heuristics perspective machine learning model on the feature vector generated from vectorizing the values. The heuristics perspective machine learning model can be an individual model, such as a support vector machine (SVM), or be an ensemble itself (e.g., XGBoost (Extreme Gradient Boosting) model, Gradient Boosting model, random forest model, etc.). The description refers to this model as the “heuristics” perspective machine learning model because it was trained from the perspective of values found in payloads determined to include insecure deserialization based on observations/heuristics. Operational flow proceeds to block 319.

At block 319, the insecure deserialization detector generates an insecure deserialization detection verdict based on predictions from the models. For instance, the insecure deserialization detector can be configured to select the malicious prediction if the predictions diverge. If both predictions are for a same class (i.e., benign or malicious), then the insecure deserialization detector can compute an average or select a maximum prediction. The insecure deserialization detector may apply thresholds to both predictions, select the prediction(s) that satisfies its corresponding threshold, and then aggregate to determine a final verdict. Implementations can vary for processing predictions that disagree. For instance, each model or classifier can be assigned a weight or factor. If the predictions disagree, then the factors can be applied to the respective one of the predictions and the results summed. The implementation can then evaluate the sum against a threshold to determine whether the verdict of benign or malicious is generated.

In some cases, a payload may include multiple object chains. FIG. 4 is a flowchart of example operations for resolving multiple object chains to an insecure deserialization prediction. The operations of FIG. 4 correspond to the execution path for the object chain vectorization and prediction. The operations of FIG. 4 would begin after block 305 of FIG. 3. At block 401, the insecure deserialization detector determines whether multiple object chains were reconstructed from a serialized string from a payload. If not, operational flow proceeds to block 307 and block 309 of FIG. 3. If multiple chains were reconstructed, the insecure deserialization detector begins processing each object chain at block 403. At block 405, the insecure deserialization detector vectorizes the object chain to generate an object-chain based feature vector. This would be similar to the operation at block 309 of FIG. 3. At block 407, the insecure deserialization detector invokes an object chain perspective deep learning model on the object chain-based feature vector. This would be similar to the operation of block 313 of FIG. 3. At block 408, the insecure deserialization detector determines whether the prediction based on the object chain is malicious. If the prediction is malicious, then operational flow proceeds to block 413. At block 413, the insecure deserialization detector indicates the malicious prediction and then at block 319 the insecure deserialization detector generates a verdict based on this object chain based malicious prediction and the prediction from the heuristics-based classification. In this implementation, the insecure deserialization detector does not evaluate the other object chains since a malicious prediction for any one of the object chains controls. If there was not a malicious prediction, then the insecure deserialization detector determines whether there is an additional object chain to process at block 409. If so, operational flow returns to block 403. Otherwise, operational flow proceeds to block 415. If none of the predictions is malicious, then the insecure deserialization detector selects a lowest confidence benign prediction at block 415. This could be a conservative approach.

Implementations are not limited to choosing the lower benign prediction and could calculate an average of the benign predictions, for example. Operational flow proceeds from block 415 to block 319 of FIG. 3.

FIG. 5 is a flowchart of example operations for training models to detect insecure deserialization based on multiple perspectives of a payload. While the example operations do not delve into common details of training (e.g., split training, epochs, batches, etc.), the operations indicate the separate training paths for machine learning models to obtain a multiple perspective insecure deserialization detector. Some of the pre-processing will be similar to that described in FIG. 3 and will not be repeated in detail.

At block 501, a trainer obtains a labeled raw training dataset of packet payloads with serialized data patterns in different programming languages. The training dataset includes benign payloads with serialized data and malicious payloads with insecure deserialization.

At block 503, the trainer decodes the packet payloads to obtain serialized strings and parses the serialized strings according to corresponding programming language to reconstruct object chains and to extract values from the serialized strings. The trainer tokenizes the extracted values and the object chains and performs feature extraction. This would be similar to blocks 301, 303, 305 in FIG. 3. The samples from the raw training dataset may be annotated to indicate the programming language and allow the trainer to eschew examining the payload to identify programming language.

Similar to FIG. 3, the execution paths for training the heuristics perspective machine learning model and for training the object chain perspective deep learning model are different. At block 505, the trainer vectorizes each set of values extracted from each packet payload according to programming language. The trainer propagates the labels according to the sample source (i.e., from the raw payload). At block 507, the trainer runs a training algorithm to train a machine learning model on heuristics-based features, the values or embeddings of the values being features. A machine learning model library will define a training function. The machine learning model will learn the values and combinations of values that have been observed as corresponding to insecure deserialization. Operational flow proceeds to block 513.

At block 509, the trainer vectorizes the object chain(s) of each serialized string according to programming language and labels according to sample source. At block 511, the trainer runs a training algorithm to train a deep neural network model on object chain-based feature vectors. The deep learning model learns correspondence between object chains and insecure deserializations.

At block 513, the trainer adds an aggregation layer to the trained models. To form the multi-perspective machine learning ensemble, an aggregation layer is added. The aggregation layer encapsulates the functionality for generating a verdict based on the predictions from the models. Different implementations of insecure deserialization detectors can be created by adding different aggregation layers. In addition, embodiments can eschew an aggregation layer when training. In deployment, the trained models can be run in parallel.

### XML External Entities Detection

The XML 1.0 standard defines an entity as a storage unit without specifying a type of storage unit and differentiates external entities and internal entities. An internal entity has a value for an entity definition. An external entity is an entity that is not an internal entity. The standard provides the below example of a declaration of an external entity.
ExternalID ::=‘SYSTEM’ S SystemLiteral
   ‘PUBLIC’ S PubidLiteral S SystemLiteral
NDataDecl ::=S ‘NDATA’ S Name
   SystemLiteral is a system identifier that a parser will convert into a URI (Uniform Resource Identifier) reference.

A malicious actor will insert tainted data into an external entity declaration in an XML document. When the XML parser parses the XML document and dereferences the system identifier, it will inadvertently access the tainted data. Various attacks leverage external entities. For instance, some attack vectors apply document type definition (DTD) usage for an XXE injection attack. A document type declaration will contain or reference markup declarations that provide grammar (i.e., DTD). The document type declaration can point to an external subset (a type of external entity) that includes part of a DTD.

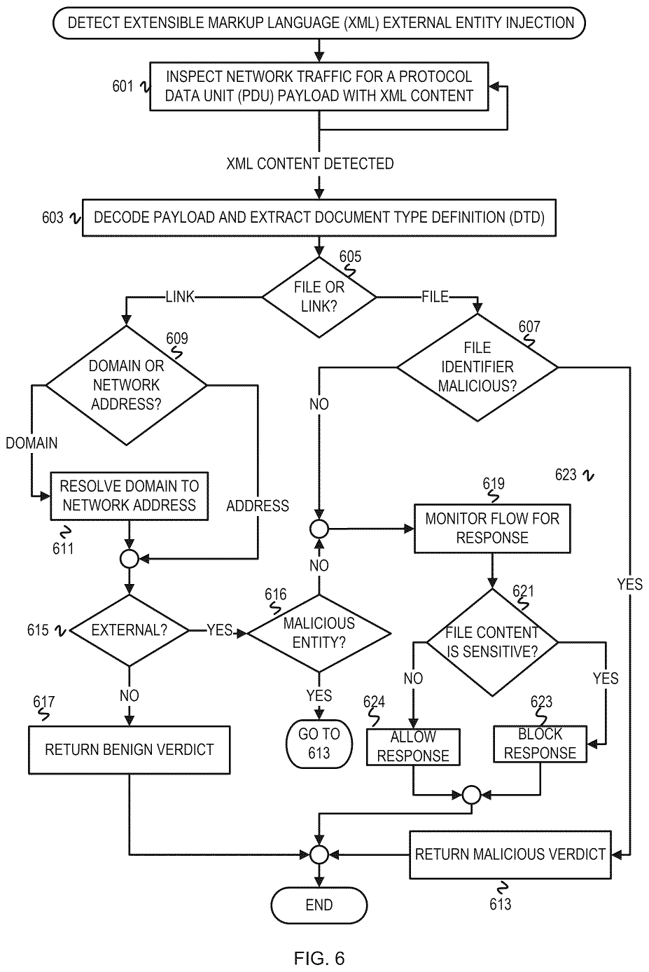

The XXE injection detector 107 previously disclosed in FIG. 1 will apply several rules to detect an XXE injection attack. FIG. 6 is a flowchart of example operations for inline detection of an XXE injection. As previously stated, pattern detection and the payload evaluation can be local and remote, respectively. Or the pattern detection and payload evaluation can be local. Regardless of the specific implementation, at least pattern detection while inspecting network traffic facilitates inline detection of an XXE injection attack.

At block 601, network traffic is inspected to determine whether a PDU payload matches a pattern indicating the presence of XML content. For example, a cybersecurity appliance (e.g., firewall) inspects payloads for XML syntax to determine the presence of XML content. Examples of XML syntax include XML declarations or XML prologs. This scanning is ongoing. If XML content is detected in a payload, then operational flow proceeds to block 603. Proceeding of operational flow can correspond to a cybersecurity appliance requesting analysis by a service implementing the XXE injection detector.

At block 603, the XXE injection detector decodes a payload and extracts a DTD from the payload. For example, the XXE injection detector can use a URL decoder or a HTML decoder. The XXE injection detector then parses the decoded payload to locate the DOCTYPE declaration and extract the DTD.

At block 605, the XXE injection detector determines whether the DTD is link-based or file-based. The DOCTYPE declaration will specify the keyword file and a file identifier for a file-based DTD and will indicate a URL for an external link-based type of DTD. If a DTD is a file, then operational flow proceeds to block 607. If the DTD is link-based, then operational flow will proceed to block 609.

At block 607, the XXE injection detector determines whether the file identifier matches a file identifier on a list of known malicious files. The XXE injection detector may also determine whether the file identifier matches an identifier of known sensitive files. The list of malicious files can be maintained by the provider of the XXE injection detector and/or provided from a third party (e.g., open source cyberthreat intelligence, government publications, etc.). If the file identifier is found on the list of malicious file identifiers, then operational flow proceeds to block 613. At block 613, a malicious verdict is returned for a cybersecurity appliance to perform a security action accordingly, such as blocking the corresponding PDU and/or subsequent PDUs of the corresponding network traffic flow. If a match for the file identifier is not found on the malicious file list, then operational flow proceeds to block 619.

If the DTD is determined to be link-based at block 605, then the XXE injection detector determines whether the link-based DTD is a URL that directs to a network address or a URL that indicates a domain. If the URL includes a network address, then operational flow proceeds to block 615. If the URL includes a domain name, then operational flow proceeds to block 611.

At block 611, the XXE injection detector resolves the URL to a network address. For instance, the XXE injection detector requests the network address from a domain name system (DNS) server. Operational flow proceeds to block 615.

At block 615, the XXE injection detector determines whether the network address is an external network address with respect to the network being protected. The XXE injection detector can apply a subnet mask of the protected network to determine whether the network address is external or internal. If the network address is an internal address, then a benign verdict is returned at block 617 and the corresponding traffic is allowed. For an external network address, operational flow proceeds to block 616.

At block 616, the XXE injection detector determines whether the external network address has been designated as malicious. The XXE injection detector can query threat intelligence data sources to determine whether the external network address is malicious. If the external network address is determined to not be malicious, then operational flow proceeds to block 619. If the external network address is determined to be malicious, then operational flow proceeds to block 613.

If the file identifier of a file-based DTD was not determined to be malicious or the external network address of a link-based DTD was determined to not be malicious, then the XXE injection detector notifies the cybersecurity appliance to monitor the network traffic flow for a response. In some cases, the cybersecurity appliance would monitor the response traffic regardless. When a response is detected with the DTD file, the cybersecurity appliance examines the file to determine whether it includes sensitive content to prevent data exfiltration. If the file includes sensitive content, then the response is blocked at block 623. Otherwise, the response is allowed at block 624.

### Variations

While the example illustrations describe the insecure deserialization detector having two machine learning models, embodiments are not so limited. An embodiment may use pattern matching logic based on heuristics to detect insecure deserialization instead of a machine learning model that has been trained on the heuristics.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

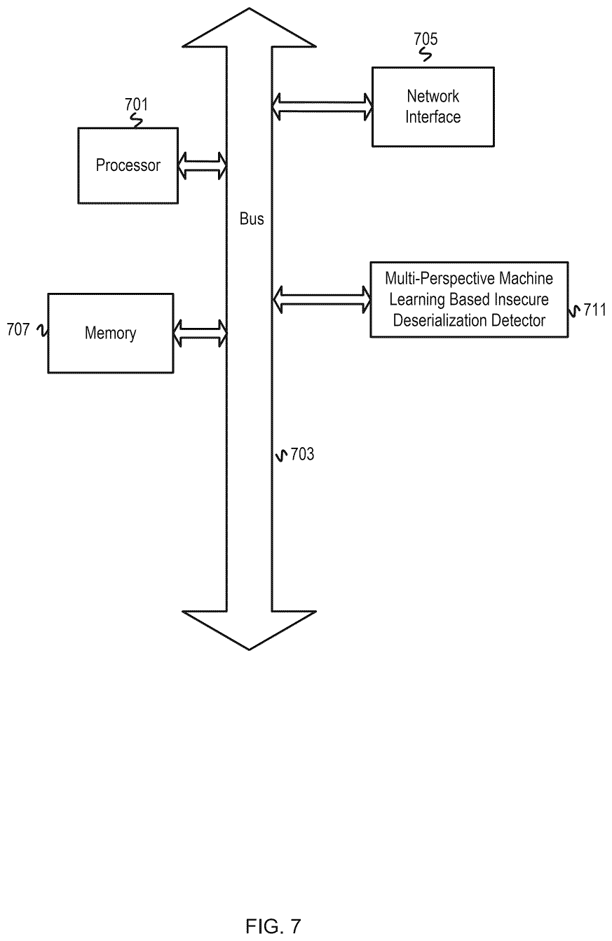

FIG. 7 depicts an example computer system with a multi-perspective machine learning based insecure deserialization detector. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes multi-perspective machine learning based insecure deserialization detector 711 (hereinafter “insecure deserialization detector”). The insecure deserialization detector 711 is built from a machine learning model or machine learning ensemble (“first model”) and a deep learning model (“second model”). A training dataset is created from benign packet payloads with serialized data and malicious packet payloads with insecure deserialization data. The training data can be annotated to indicate the programming language of each sample, or a training pipeline can include identifying the programming language of each sample. From the raw training data, two different feature sets are extracted: 1) object chains and 2) values. The values-based feature set is used to train the first model. The values are values assigned to fields or keys in the serialized data. The parser will detect the keys/fields according to the programming language of the corresponding sample. The object chain-based feature set is used for training the second model. An aggregation layer is added to the trained models for generating a verdict based on predictions from the trained models. The trained detector can then be deployed as an accessible application or service from security appliances (e.g., firewalls) scanning network traffic to facilitate inline detection. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc.

Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

The description refers to a protocol data unit (PDU). This term is often used to refer to the unit of data communicated regardless of communication protocol and includes at least a header and payload or payload and encapsulation. A PDU may be a frame, packet, datagram, message, etc. depending upon the corresponding communication protocol.

1. A method comprising:
inspecting inline payloads of network traffic, wherein inspecting the payloads comprises inspecting the payloads for at least one of a plurality of patterns corresponding to a plurality of cyberattacks;
based on detection of a first of the plurality of patterns in a first payload,
invoking a first of a plurality of attack detectors according to the first pattern that was detected, wherein the plurality of attack detectors comprises a cross-site scripting attack detector, an extensible markup language (XML) external entity (XXE) injection attack detector, an insecure deserialization detector, and a malicious XML detector;
the first attack detector analyzing the first payload for the corresponding one of the plurality of cyberattacks and returning a verdict; and
blocking or allowing network traffic of a network traffic flow corresponding to the first payload based on the returned verdict.

2. The method of claim 1, wherein invoking the first attack detector comprises communicating a request for analysis to the first detector, wherein the request includes either the first payload or a packet that includes the first payload.

3. The method of claim 1, wherein the first pattern indicates presence of XML content in the first payload and the first attack detector analyzing the first payload comprises analyzing the first payload to detect an XXE injection attack which comprises:
determining whether a declaration in the first payload indicates a link-based document type definition (DTD) or a file-based DTD;
based on a determination that the declaration indicates a file-based DTD, determining whether a file identifier in the declaration identifies a malicious file and returning a malicious verdict if the file identifier identifies a malicious file; and
based on a determination that the declaration indicates a link-based DTD, determining whether a network address for the DTD is a malicious external network address and returning a malicious verdict if the network address is a malicious external network address.

4. The method of claim 3, wherein determining whether a network address for the DTD is a malicious external network address comprises determining that the network address is external and then querying a cyberthreat intelligence data source to determine whether the external network address is malicious.

5. The method of claim 3 further comprising, after determining that the declaration indicates a link-based DTD, determining whether the declaration includes a uniform resource locator (URL) having a domain name or the network address and, based on a determination that the URL has a domain name, resolving the domain name to the network address.

6. A method comprising:
identifying a programming language corresponding to serialized data extracted from a payload of a packet;
decoding the serialized data to obtain a serialized string;
parsing, based on the programming language, the serialized string to reconstruct an object chain and to extract values from the serialized string;
vectorizing the object chain to generate a first feature vector and vectorizing the extracted values to generate a second feature vector;
invoking a first machine learning model on the first feature vector to obtain a first prediction;
invoking a second machine learning model on the second feature vector to obtain a second prediction; and
generating a verdict for insecure deserialization detection based on the first and second predictions.

7. The method of claim 6, further comprising scanning network traffic for a pattern or regular expression that indicates presence of serialized data in a payload of a packet, wherein the payload included the pattern or regular expression.

8. The method of claim 6, further comprising tokenizing the extracted values and/or the object chain.

9. The method of claim 6, wherein generating the verdict comprises aggregating the first and second predictions.

10. The method of claim 9, wherein aggregating the first and second predictions comprises one of averaging the first and second predictions, selecting one of the first and second predictions that satisfies a corresponding threshold, and selecting a greater of the first and second predictions.

11. The method of claim 6 further comprising loading a parser for the identified programming language, wherein parsing the serialized data is with the loaded parser.

12. The method of claim 6, wherein the first machine learning model comprises a deep learning model that has been trained to classify feature vectors generated based on object chains as malicious or benign with respect to presence of insecure deserialization and the second machine learning model is a machine learning model or machine learning ensemble that has been trained to classify feature vectors generated based on values extracted from payloads or tokens generated from values extracted from payloads as malicious or benign with respect to presence of insecure deserialization.

13. A non-transitory, machine-readable medium having program code stored thereon, the program code comprising instructions to:
identify a programming language corresponding to serialized data extracted from a payload of a packet;
decode the serialized data to obtain a serialized string;
parse, based on the programming language, the serialized string to reconstruct an object chain and to extract values from the serialized string;
vectorize the object chain to generate a first feature vector and vectorizing the extracted values to generate a second feature vector;
invoke a first machine learning model on the first feature vector to obtain a first prediction;
invoke a second machine learning model on the second feature vector to obtain a second prediction; and
generate a verdict for insecure serialization detection based on the first and second predictions.

14. The non-transitory, machine-readable medium of claim 13, wherein the program code further comprising instructions to scan network traffic for a pattern or regular expression that indicates presence of serialized data in a payload of a packet.

15. The non-transitory, machine-readable medium of claim 13, wherein the program code further has stored thereon instructions to tokenize the extracted values and/or the object chain.

16. The non-transitory, machine-readable medium of claim 13, wherein the instructions to generate the verdict comprise instructions to aggregate the first and second predictions.

17. The non-transitory, machine-readable medium of claim 16, wherein the instructions to aggregate the first and second predictions comprise at least one of instructions to average the first and second predictions, instructions to select one of the first and second predictions that satisfies a corresponding threshold, and instructions to select a greater of the first and second predictions.

18. The non-transitory, machine-readable medium of claim 13, wherein the program code further has stored thereon instructions to load a parser for the identified programming language to parse, wherein the instructions to parse comprise the parser.

19. The non-transitory, machine-readable medium of claim 13, wherein the first machine learning model comprises a deep learning model that has been trained to classify feature vectors generated based on object chains as malicious or benign with respect to presence of insecure deserialization and the second machine learning model is a machine learning model or machine learning ensemble that has been trained to classify feature vectors generated based on values extracted from payloads or tokens generated from values extracted from payloads as malicious or benign with respect to presence of insecure deserialization.

20. A system comprising:
a processor; and
a machine-readable medium having instructions stored thereon that are executable by the processor to cause the system to, identify a programming language corresponding to serialized data extracted from a payload of a packet;
decode the serialized data to obtain a serialized string;
parse, based on the programming language, the serialized string to reconstruct an object chain and to extract values from the serialized string;
vectorize the object chain to generate a first feature vector and vectorizing the extracted values to generate a second feature vector;
invoke a first machine learning model on the first feature vector to obtain a first prediction;
invoke a second machine learning model on the second feature vector to obtain a second prediction; and
generate a verdict for insecure serialization detection based on the first and second predictions.

21. The system of claim 20 further comprising a network device having a second processor and a second machine-readable medium that has stored thereon instructions executable by the second processor to cause the network device to scan network traffic for a pattern or regular expression that indicates presence of serialized data in a payload of a packet.

22. The system of claim 20, wherein the machine-readable medium further has stored thereon instructions executable by the processor to cause the system to tokenize the extracted values and/or the object chain.

23. The system of claim 20, wherein the instructions to generate the verdict comprise instructions executable by the processor to cause the system to aggregate the first and second predictions.

24. The system of claim 20, wherein the machine-readable medium further has stored thereon instructions executable by the processor to cause the system to load a parser for the identified programming language to parse, wherein the instructions to parse comprise the parser.

25. The system of claim 20, wherein the first machine learning model comprises a deep learning model that has been trained to classify feature vectors generated based on object chains as malicious or benign with respect to presence of insecure deserialization and the second machine learning model is a machine learning model or machine learning ensemble that has been trained to classify feature vectors generated based on values extracted from payloads or tokens generated from values extracted from payloads as malicious or benign with respect to presence of insecure deserialization.
